(19) United States
(12) Patent Application Publication
(10) Pub. No.: US 2015/0199077 A1
(43) Pub. Date: Jul. 16, 2015

(54) SCHEDULING AND VIEWING A CALENDER EVENT USING TIME ZONES BASED ON A USER'S LOCATION AT EVENT TIME

(71) Applicant: GOOGLE INC., Mountain View, CA (US)

(72) Inventors: Robin Züger, Zurich (CH); Daniel Michael GREENBLATT, Zurich (CH)

(73) Assignee: GOOGLE INC., Mountain View, CA (US)

(21) Appl. No.: 13/901,348

(22) Filed: May 23, 2013

(51) Int. Cl. G06F 3/0481

(52) U.S. Cl. CPC G06F 3/0481

(57) ABSTRACT

A system and method for changing event time zones in a calendar based on a user's location are disclosed. A calendar system may receive information regarding a user's location for a specified time zone. The calendar system may use this information for scheduling events for the specified time zone or for determining whether previously-scheduled events fall outside a preferred time period. Time zones and preferred time periods may be set by the user. The user may view the time zone changes as well as events in several different time zones. Other users may also view the time zone changes in a user's calendar.

### BACKGROUND

Scheduling events with family, friends, and colleagues can often be difficult given people's busy and demanding lives. Event scheduling can be further complicated by people traveling among several different time zones. For example, a person may be living in New York and visiting San Francisco near the end of the week. Today may be Monday and the person may want to schedule a lunch with a friend for 12 pm on Thursday when the person is in San Francisco. Since the lunch will occur in San Francisco, the lunch should be scheduled for 12 pm Pacific Standard Time (PST). However, when the person is looking at his calendar today as illustrated in FIG. 1, the calendar displays times in the person's local time zone, or Eastern Standard Time (EST). The person may not think about time zones when scheduling Thursday's lunch and may schedule the lunch for 12 pm Thursday using the person's current calendar display. A customary scheduling system will schedule the lunch in the person's current time zone. Therefore, the lunch may be scheduled for 12 pm EST which is 9 am PST. There should be a calendar system that determines the time zone in which a user will be for any given day and displays the user's calendar in the determined time zone in order to prevent events from being scheduled for the wrong time.

### SUMMARY

This specification describes technologies relating to calendar presentation in general, and specifically to methods and systems for scheduling and displaying time zones based on a user's past, current, or future location.

In general, one aspect of the subject matter described in this specification can be embodied in systems and methods for displaying calendar events in multiple time zones and changing a calendar's time zone based on a user's location. An exemplary system includes: one or more processing devices and one or more storage devices, storing instructions that, when executed by the one or more processing devices, cause the one or more processing devices to display one or more events in an electronic calendar for a current time period in a user's first time zone and display events in the electronic calendar for a future time period in a second time zone different from the user's current location without changing the user's first time zone in the electronic calendar. A second exemplary system includes: one or more processing devices and one or more storage devices, storing instructions that, when executed by the one or more processing devices, cause the one or more processing devices to receive a user's location information for a specified time period, the further location being in a different time zone from the user's current location, receive a request from the user to create a calendar event during the specified time period, create the calendar event in the time zone associated with the user's future location information for the specified time period, and display the calendar event in the time zone associated with the user's future location information for the specified time period. A third exemplary system includes: one or more processing devices and one or more storage devices, storing instructions that, when executed by the one or more processing devices, cause the one or more processing devices to receive a user's location information for a specified time period which indicates a change in the user's time zone for the specified time period, find all scheduled events for the specified time period, determine if any of the events are outside a preferred time period based on the change in the user's time zone, and responsive to an event being outside the preferred time period, notify the user of the event/time period conflict.

An exemplary method includes: displaying one or more events in an electronic calendar for a current time period in a user's first time zone and displaying events in the electronic calendar for a future time period in a second time zone different from the user's current location without changing the user's first time zone in the electronic calendar. A second exemplary method includes: receiving a user's future location information for a specified time period, the future location being in a different time zone from the user's current location, receiving a request from the user to create a calendar event during the specified time period, creating the calendar event in the time zone associated with the user's future location information for the specified time period, and displaying the calendar event in the time zone associated with the user's future location information for the specified time period. A third exemplary method includes: receiving a user's location information for a specified time period which indicates a change in the user's time zone for the specified time period, finding all scheduled events for the specified time period, determining if any of the events are outside a preferred time period based on the change in the user's time zone, and responsive to an event being outside the preferred time period, notifying the user of the event/time period conflict.

These and other embodiments can optionally include one or more of the following features: a future time period may correspond to a future scheduled trip in a time zone different from the user's current location, the second time zone may automatically be determined, a second end user may be allowed to view the second time zone for the future time period, an end user may be allowed to view the second time zone for the future time period, a determination may be made to decide whether an existing event is outside a preferred time period in response to a change in the user's time zone for the event's time period, a second end user may be allowed to view the user's time zone changes, a user's future location information may be received manually, other users may be allowed to view the user's time zone changes, the user may be allowed to view time zone changes, the user's future location information may be received by harvesting information from the user's email and using the harvested data to determine the user's location information for a future time period, and the user's future location information may be received manually as a time zone from the user.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating a customary calendar system display.

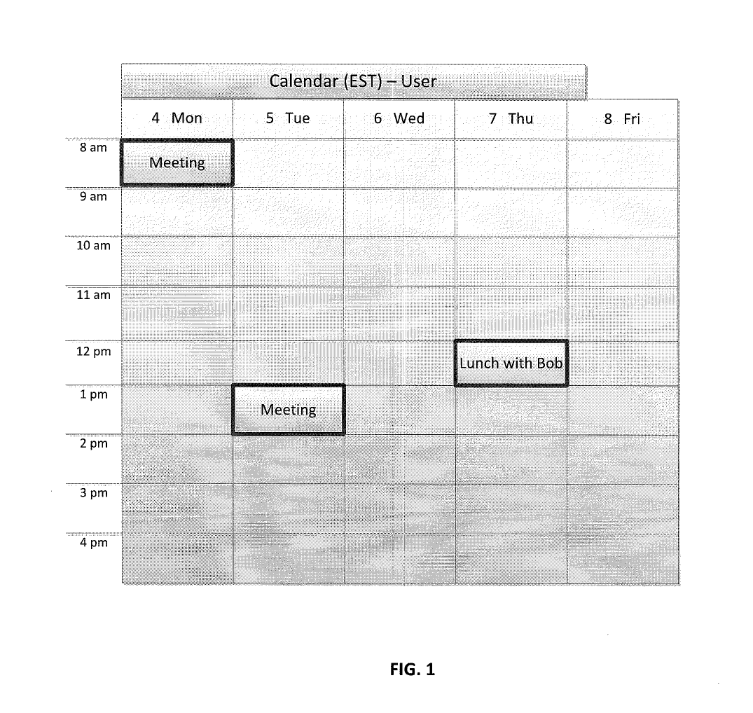

FIG. 2 is a block diagram illustrating an exemplary calendar system display.

FIG. 3 is a flow diagram of an exemplary method for changing event time zones in a calendar system based on a user's location.

FIG. 4 is a flow diagram of an exemplary method for changing event time zones in a calendar system based on a user's location.

FIG. 5 is a block diagram illustrating an exemplary computing device.

FIG. 6 is a flow diagram of an exemplary method for changing event time zones in a calendar system based on a user's location.

### DETAILED DESCRIPTION

In general, the techniques described in this document can be used to schedule and display events in a user's calendar. The calendar application may change a user's time zone based on the user's future or past location. Aspects of the inventive concepts also provide a way to determine a user's future or past locations in addition to the user's current location.

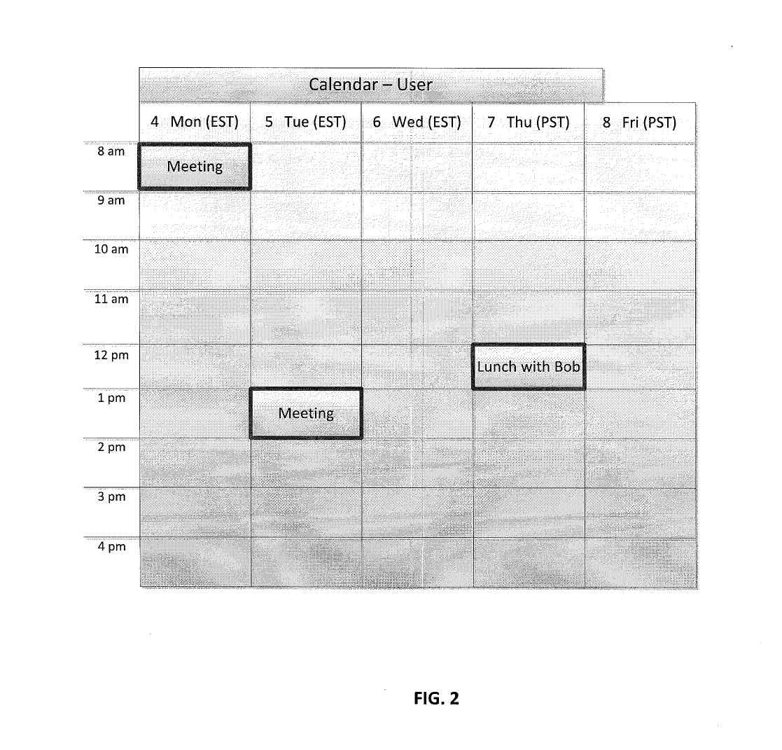

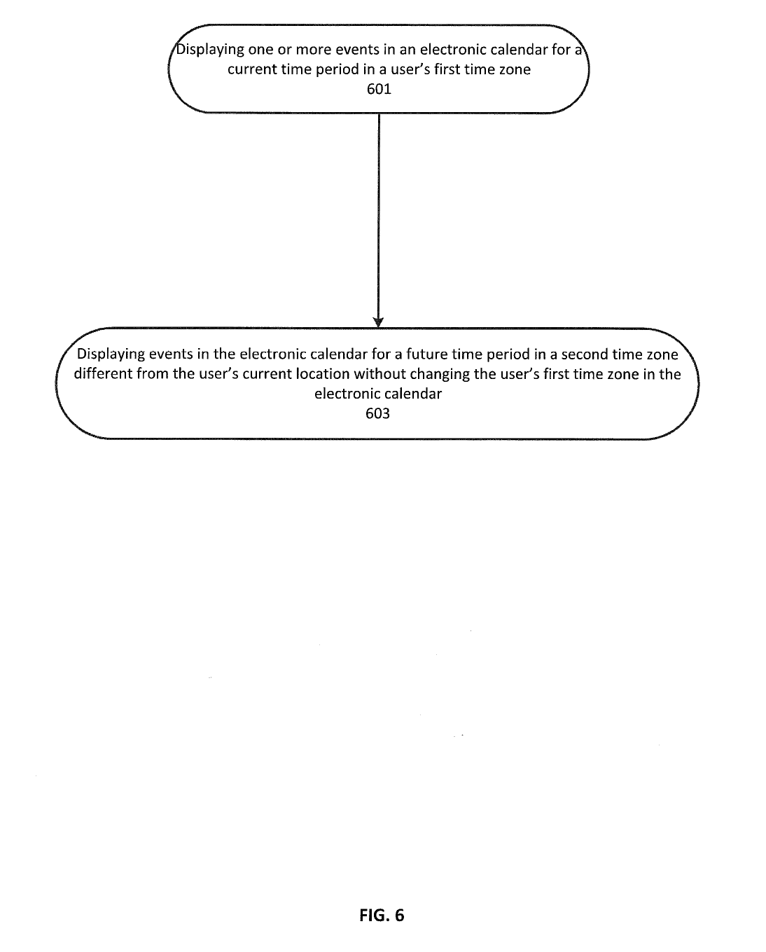

Customary calendar systems always display a user's entire calendar in the time zone in which the user viewing the calendar is currently located. However, the user's current time zone may not be the most appropriate time zone for every day or every event in the calendar. Therefore, an exemplary calendar system may allow a user to view and schedule events in a calendar using the time zone in which the user was for past events or the time zone in which the user will be for future events as illustrated in FIG. 2. FIG. 6 shows that an exemplary method begins with the system displaying one or more events in an electronic calendar for a current time period in a user's first time zone and displaying events in the electronic calendar for a future time period in a second time zone different from the user's current location without changing the user's first time zone in the electronic calendar.

Allowing a calendar to display and schedule events in multiple time zones requires that the calendar system know users' locations, and corresponding time zones. One way for an exemplary calendar system to know where a user was or will be is by knowing the flights the user is taking. Flight confirmations are generally sent via email. An exemplary calendar system may receive flight information or other pertinent user location information from an email system. An exemplary calendar system may also track a user's location based on global positioning system (GPS) and/or cell tower information from the user's smartphone. Alternatively, a user may enter location information or define a future time zone manually. An exemplary calendar system may allow a user to specify that he will be in a particular location or time zone for a specific date or time range. The calendar system may then be able to display that date or time range in the appropriate time zone. Various databases and/or look up tables may be used to map an airport, or any location, to a time zone. The system may also determine the user's location and time zone for time periods other than the current time period. Determination of the user's location for past or future time periods may be made by using received information. A user's location for a given day may be determined using information parsed from the user's email. Alternatively, location may be determined using global positioning satellite (GPS) and/or cell tower information corresponding to the user's cell phone, smartphone, tablet, or other electronic device. Location may also be entered manually by a user. For example, a user may enter information into an exemplary calendar system that suggests that the user will be in a particular location from day X to day Y. In the time range from day X to day Y, an exemplary calendar system may display events in the time zone of the user specified location.

For example, a future time period may correspond to a scheduled trip. A user's email may contain a flight reservation for a flight to San Francisco from Thursday to Monday. An exemplary system may use this information to automatically determine that the calendar events from Thursday to Monday should be scheduled and displayed in PDT/PST. Therefore, the user does not need to worry about translating events to the right time zone before scheduling future events that will occur in a time zone different from the time zone in which the user is currently located.

An exemplary system may also be able to determine if existing events are outside a preferred period in response to a future change in time zones. A user may set up preferred time periods such as normal business hours or sleeping hours. For example, a user may set 8 am to 5 pm as a preferred time period for business. A user may schedule a business meeting for 8 am Monday morning EST/EDT as shown in FIG. 2. The user may be located in New York when he scheduled the meeting and planned to be in New York for the 8 am meeting. However, the user may need to move up his trip to San Francisco and leave on Sunday. If the user changes his flight reservation from Thursday to Sunday, an exemplary system may determine that the 8 am meeting may be outside of the user's preferred time period for business and alert the user to the potential conflict since the meeting is now scheduled for 5 am PST/PDT if the user is located in San Francisco.

Although an exemplary system may automatically change time zones based on where a user may be located for a given time period, the system may also allow a user to view the time zone changes as well as set the time zone changes manually. Furthermore, an exemplary system may allow other users with whom a user shares his calendar to view the future time zone changes to the user's calendar.

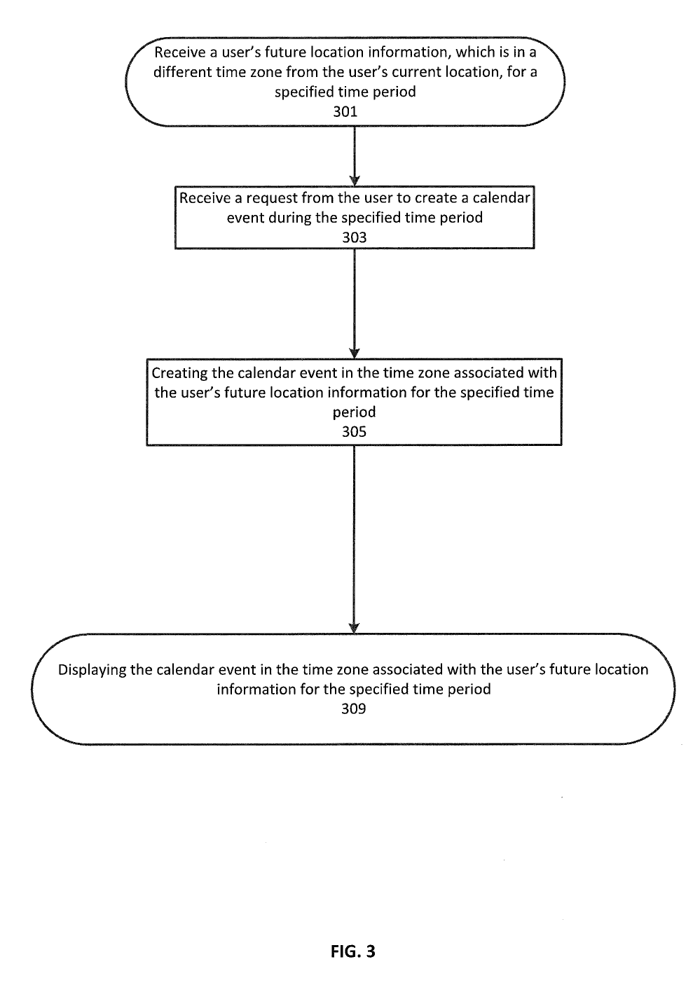

An exemplary method begins with receiving a user's location information, which is in a different time zone from the user's current location, for a specified time period as illustrated in FIG. 3 (301). The method may then receive a request from the user to create a calendar event during the specified time period (303). The method may create the calendar event in the time zone associated with the user's future location information for the specified time period. (305) An exemplary method may display times based on the future time zone, not the current time zone, when creating the event. Then, the exemplary method may display the event in the time zone associated with the user's future location information for that time period (309).

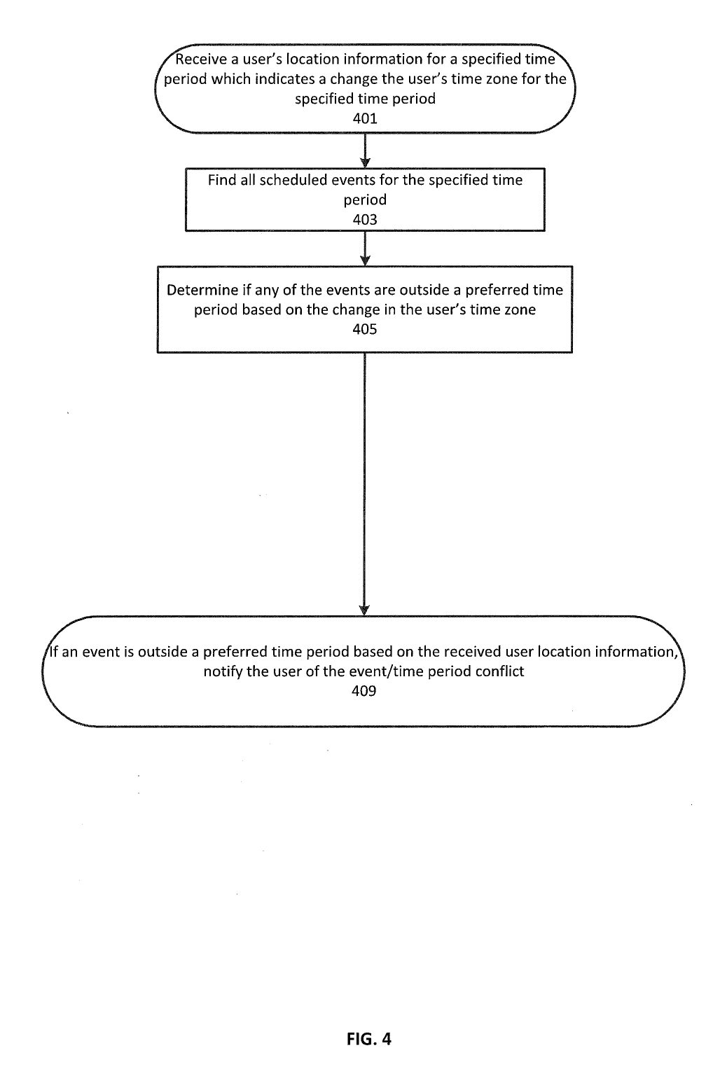

Another exemplary method begins with receiving a user's location information for a specified time period which indicates a change in the user's time zone for the specified time period as illustrated in FIG. 4 (401). The method may then find all scheduled events for the specified time period (403) and determine if any of the events are outside a preferred time period based on the received user's location information (405). If an event is outside a preferred time period based on the change of time zone, the method may notify the user of the event/time period conflict (409).

An exemplary calendar system may account for the possibility that a user may schedule events in one time zone, but then relocate to a second time zone before the events occur. For example, a user may schedule a meeting for 9 am EDT on May 3rd. However, an unexpected business trip may be scheduled for May 2nd through May 5th during which the user will be in California in pacific daylight time (PDT). When a user's time zone for a time period changes, an exemplary calendar system may find all the events that are in the user's calendar during the time period. If there are any violations with preferred time periods, such as business hours or sleeping hours, the user may be notified about the violations and may have the option to reschedule the events. Alternatively, the exemplary calendar system may let the user cancel these events.

More generally, for any event in the time period for which the time zone has changed, an exemplary calendar system may list the events for a user and suggest that the user move or cancel events, specifically events that occur in the original time zone where the user will not be located.

Exemplary methods may allow a user to view automatic time zone changes or set time zone changes manually. Furthermore, a user may be able to share his or her calendar with other users. The other users may be able to view the time zone changes in the calendar.

In some embodiments, an exemplary calendar system may notify a person scheduling an event to the time zones of event invitees. The person scheduling the event may know that a user is not in town for a specific event and be able to reschedule the event without the user having to take action. Alternatively, an exemplary system may suggest a phone call or a video conference for the users who would not be able to attend the event in person based on their location for the event time period. In order for a calendar system to provide details regarding a user's location, a user may have to give the exemplary calendar system permission to provide user location information to other calendar users.

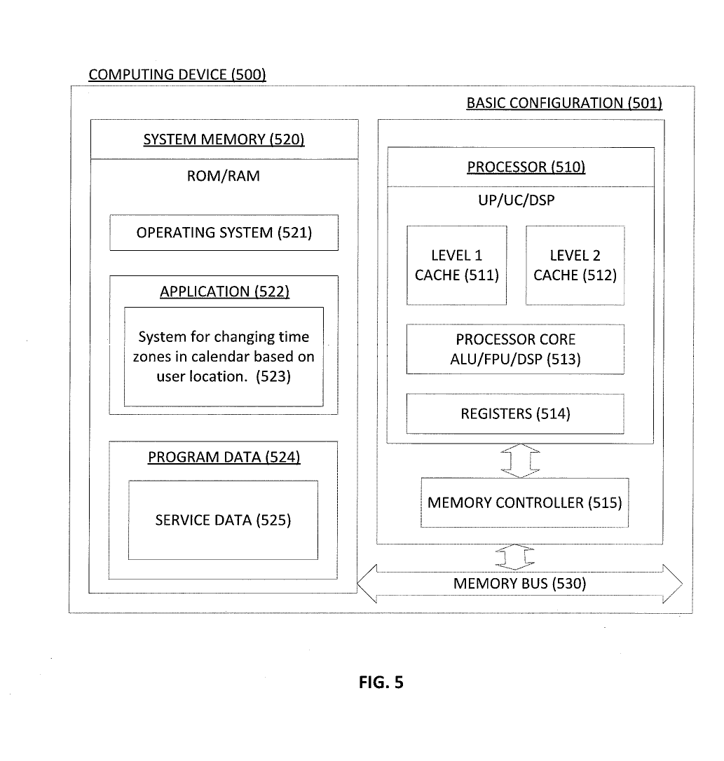

FIG. 5 is a high-level block diagram of an exemplary computer (700) that is arranged for changing time zones in a calendar based on the user's location. In a very basic configuration (501), the computing device (500) typically includes one or more processors (510) and system memory (520). A memory bus (530) can be used for communicating between the processor (510) and the system memory (520).

Depending on the desired configuration, the processor (510) can be of any type including but not limited to a microprocessor (μP), a microcontroller (μC), a digital signal processor (DSP), or any combination thereof. The processor (510) can include one more levels of caching, such as a level one cache (511) and a level two cache (512), a processor core (513), and registers (514). The processor core (513) can include an arithmetic logic unit (ALU), a floating point unit (FPU), a digital signal processing core (DSP Core), or any combination thereof. A memory controller (516) can also be used with the processor (510), or in some implementations the memory controller (515) can be an internal part of the processor (510).

Depending on the desired configuration, the system memory (520) can be of any type including but not limited to volatile memory (such as RAM), non-volatile memory (such as ROM, flash memory, etc.) or any combination thereof. System memory (520) typically includes an operating system (521), one or more applications (522), and program data (524). The application (522) may include a system for determining the user's time zone for a specified time period and creating and displaying events in the correct time zone for that time period. Program Data (524) includes storing instructions that, when executed by the one or more processing devices, implement a system and method for changing time zones in a calendar to coordinate with the user's location. (523). In some embodiments, the application (522) can be arranged to operate with program data (524) on an operating system (521).

The computing device (500) can have additional features or functionality, and additional interfaces to facilitate communications between the basic configuration (501) and any required devices and interfaces.

System memory (520) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media can be part of the device (500).

The computing device (500) can be implemented as a portion of a small-form factor portable (or mobile) electronic device such as a cell phone, a smart phone, a personal data assistant (PDA), a personal media player device, a tablet computer (tablet), a wireless web-watch device, a personal headset device, an application-specific device, or a hybrid device that include any of the above functions. The computing device (500) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, as one or more programs running on one or more processors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location). For example, users may be able to opt in to allow a calendar application to access flight information from email or another service. An exemplary system may also allow users to opt in to allow a calendar application to track their location via GPS or cell towers.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for displaying calendar events in multiple time zones comprising:
displaying one or more events in an electronic calendar for a current time period in a user's first time zone; and
displaying events in the electronic calendar for a future time period in a second time zone different from the user's current location without changing the user's first time zone in the electronic calendar.

2. The method of claim 1 wherein the future time period corresponds to a future scheduled trip in a time zone different from the user's current location.

3. The method of claim 1 further comprising automatically determining the second time zone.

4. The method of claim 1 further comprising allowing a second end user to view the second time zone for the future time period.

5. The method of claim 1 further comprising allowing an end user to set the second time zone for the future time period.

6. The method of claim 1 further comprising determining if an existing event is outside a preferred time period in response to a change in the user's time zone for the event's time period.

7. The method of claim 1 further comprising allowing a second end user to view the user's time zone changes.

8. A computer-implemented method for changing a calendar's time zone based on a user's location comprising:
receiving a user's future location information for a specified time period, the future location being in a different time zone from the user's current location;
receiving a request from the user to create a calendar event during the specified time period;
creating the calendar event in the time zone associated with the user's future location information for the specified time period; and
displaying the calendar event in the time zone associated with the user's future location information for the specified time period.

9. The method of claim 8 further comprising receiving the user's future location information manually from the user.

10. The method of claim 8 further comprising allowing other users to view the user's time zone changes.

11. The method of claim 8 further comprising allowing the user to view the time zone changes.

12. The method of claim 8 further comprising receiving the user's future location information by:
harvesting information from the user's email and
using the harvested data to determine the user's location information for a future time period.

13. The method of claim 8 further comprising receiving the user's future location information as a time zone manually from the user.

14. A computer-implemented method changing a calendar's time zone based on a user's location comprising:
receiving a user's location information for a specified time period which indicates a change in the user's time zone for the specified time period;
finding all scheduled events for the specified time period;
determining if any of the events are outside a preferred time period based on the change in the user's time zone; and
responsive to an event being outside the preferred time period, notifying the user of the event/time period conflict.

15. The method of claim 14, further comprising receiving the user's location information manually from the user.

16. The method of claim 14, further comprising allowing other users to view the user's time zone changes.

17. The method of claim 14, further comprising allowing the user to view the time zone changes.

18. The method of claim 14, further comprising receiving the user's location information by:
harvesting information from the user's email and
using the harvested data to determine the user's location information for a specified time period.

19. The method of claim 8 further comprising receiving the user's specified location information as a time zone manually from the user.
